(19) United States
(12) Patent Application Publication
(10) Pub. No.: US 2017/0260956 A1
(43) Pub. Date: Sep. 14, 2017

(54) STARTER ASSEMBLY WITH REVERSIBLE STARTER

(71) Applicant: Schaeffler Technologies AG & Co. KG, Herzogenaurach (DE)

(72) Inventors: Larry Haines, Coshocton, OH (US); Philip George, Wooster, OH (US); Jeffrey Hemphill, Copley, OH (US); Mark Robert Milliren, Barberton, OH (US)

(73) Assignee: Schaeffler Technologies AG & Co. KG, Herzogenaurach (DE)

(21) Appl. No.: 15/606,946

(22) Filed: May 26, 2017

Related U.S. Application Data
(63) Continuation-in-part of application No. 14/717,682, filed on May 20, 2015.

(51) Int. Cl. F02N 15/02; F02N 15/00; F02N 11/08; F02N 15/04

(52) U.S. Cl. CPC F02N 15/022; F02N 15/046; F02N 15/006; F02N 11/0859; F02N 15/02; F02N 15/04; F02N 15/043; F02N 11/08; H02K 23/00

(57) ABSTRACT

A starter assembly including a starter and starting device. The starter includes: an electric motor including a motor shaft; an output shaft non-rotatably connected to the motor shaft; and a one-way clutch including a first race including an axially fixed pinion gear and a second race non-rotatably connected to the output shaft. The starting device includes a wrap spring clutch with first and second ends. For a start mode: the electric motor rotates the motor shaft and the pinion gear in a first circumferential direction; the pinion gear rotates the second end, with respect to the first end, in the first circumferential direction; and, the wrap spring clutch rotates a torque converter shell in the first circumferential direction. For a first phase of a release mode: the electric motor rotates the second race in a second circumferential direction; and the first race rotates in the second circumferential direction.

### CROSS-REFERENCE TO RELATED APPLICATIONS

This is a continuation-in-part patent application under 35 U.S.C. 120 of U.S. patent application Ser. No. 14/717,682, filed May 20, 2015, which application is incorporated herein by reference in its entirety.

### TECHNICAL FIELD

The present disclosure relates to a starter assembly for an internal combustion engine. In particular, to a starter assembly with a starter having a reversible motor and an axially fixed pinion gear.

### BACKGROUND

Known starter motors include a retractable pinion gear disengageable from a flywheel of a combustion engine after a starting sequence. The engagement and disengagement of the pinion gear can cause damage to respective gear teeth on the pinion gear and flywheel and also places a high current load on the starter motor, which can lead to premature failure of the rotor and brushes. Further, the pinion gear and the ring gear may clash if the ring gear is rotating when the pinion gear is engaged with the ring gear.

It is known to use a wrap spring clutch to rotate a torque converter shell with a starter motor to start an internal combustion engine. The clutch is wrap, or wound, about the shell and then rotated in a first circumferential direction. However, at times the clutch does not properly unwind in a second, opposite, circumferential direction to terminate the starting process.

### SUMMARY

According to aspects illustrated herein, there is provided a starter assembly for a motor vehicle, including a starter and a starting device. The starter includes: a housing; an electric motor located within the housing and including a motor shaft; an axis of rotation for the motor shaft; an output shaft non-rotatably connected to the motor shaft; and a one-way clutch including a first race including a pinion gear, the pinion gear fixed with respect to axial movement, parallel to the axis of rotation, with respect to the housing and a second race non-rotatably connected to the output shaft.

The starting device includes a wrap spring clutch with a first end and a second end. The first race and the pinion are non-rotatably connected. For a start mode: the electric motor is arranged to rotate the motor shaft and the pinion gear in a first circumferential direction; the pinion gear is arranged to rotate the second end, with respect to the first end, in the first circumferential direction; and, the wrap spring clutch is arranged to rotate a torque converter shell in the first circumferential direction. For a first phase of a release mode: the electric motor is arranged to rotate the second race in a second circumferential direction, opposite the first circumferential direction; and the first race rotates in the second circumferential direction.

According to aspects illustrated herein, there is provided a starter assembly for a motor vehicle, including a starter and a starting device. The starter includes: a housing; an electric motor located within the housing and including a motor shaft; an axis of rotation for the motor shaft; an output shaft non-rotatably connected to the motor shaft; and a one-way clutch including a first race including a pinion gear, the pinion gear fixed with respect to axial movement, parallel to the axis of rotation, with respect to the housing, a second race non-rotatably connected to the output shaft and a resilient element frictionally engaged with the first and second races. The starting device includes a wrap spring clutch with a first end and a second end. The first race and the pinion are non-rotatably connected. For a start mode: the electric motor is arranged to rotate the motor shaft and the pinion gear in a first circumferential direction; the pinion gear is arranged to rotate the second end, with respect to the first end, in the first circumferential direction; and the wrap spring clutch is arranged to rotate a torque converter shell in the first circumferential direction. For a first phase of a release mode: the electric motor is arranged to rotate the second race in a second circumferential direction, opposite the first circumferential direction; and the resilient element, the first race and the second race are arranged to rotate in the first circumferential direction.

According to aspects illustrated herein, there is provided a starter assembly for a motor vehicle, including a starter and a starting device. The starter includes: a housing; an electric motor located within the housing and including a motor shaft; an axis of rotation for the motor shaft; an output shaft non-rotatably connected to the motor shaft; and a one-way clutch including a first race including a pinion gear, the pinion gear fixed with respect to axial movement, parallel to the axis of rotation, with respect to the housing and a second race non-rotatably connected to the output shaft. The starting device includes: a wrap spring clutch with a first end, a center portion connected to the first end and a second end connected to the center portion; a ring gear drivingly engaged with the pinion gear; and a ring support plate drivingly engaged with the ring gear and the second end. The first race and the pinion are non-rotatably connected. For a start mode: the electric motor is arranged to rotate the pinion, the ring gear, the ring support gear in a first circumferential direction and rotate the second end, with respect to the first end, in the first circumferential direction; and the center portion is arranged to engage and rotate a torque converter shell in the first circumferential direction. To transition from the start mode to a first phase of a release mode, the electric motor is arranged to rotate: the pinion gear, the ring gear and the ring support plate in a second circumferential direction, opposite the first circumferential direction; and the second end, with respect to the first end, in the second circumferential direction.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a perspective view of a starter with an axially fixed pinion gear;

FIG. 3 is a side view of the starter in FIG. 2;

FIG. 4 is a cross-sectional view of the starter taken generally along line 4-4 in FIG. 2;

FIG. 5 is a cross-sectional view of a starter assembly including the starter of FIG. 2 and a starting device;

FIG. 6 is detail of FIG. 5;

FIG. 7 is an exploded view of the starting device of FIG. 5;

FIG. 8 is a schematic view of a control circuit for the starter in FIG. 2;

FIG. 9 is a cross-sectional view of the starter of FIG. 2 taken generally along line 9-9 in FIG. 3.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

By “non-rotatably connected” first and second components we mean that the first component is connected to the second component so that any time the first component rotates, the second component rotates with the first component, and any time the second component rotates, the first component rotates with the second component. Axial displacement between the first and second components is possible. It is not necessary for the first and second components to rotate at the same rate.

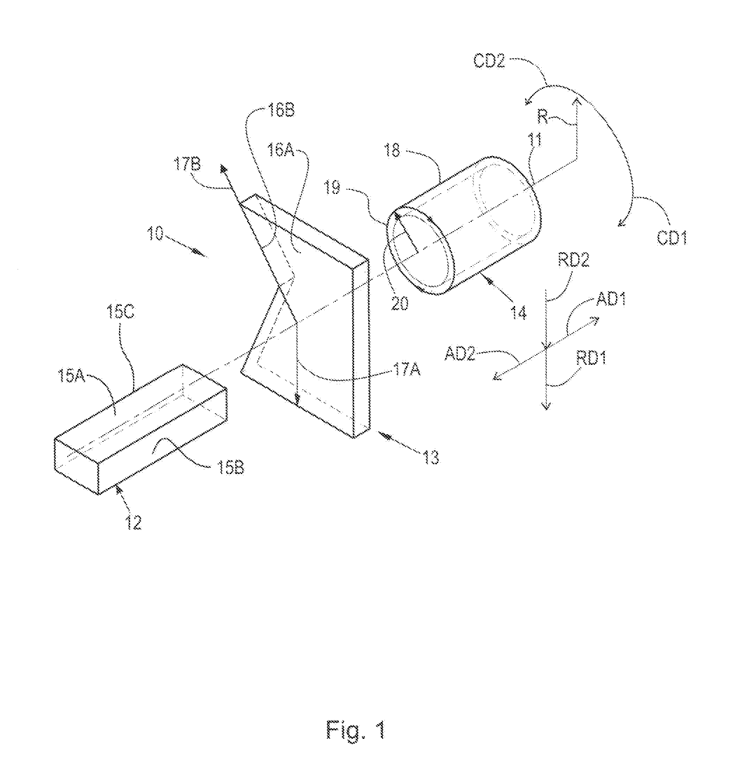

FIG. 1 is a perspective view of cylindrical coordinate system 10 demonstrating spatial terminology used in the present application. The present application is at least partially described within the context of a cylindrical coordinate system. System 10 includes axis of rotation, or longitudinal axis, 11, used as the reference for the directional and spatial terms that follow. Opposite axial directions AD1 and AD2 are parallel to axis 11. Radial direction RD1 is orthogonal to axis 11 and away from axis 11. Radial direction RD2 is orthogonal to axis 11 and toward axis 11. Opposite circumferential directions CD1 and CD2 are defined by an endpoint of a particular radius R (orthogonal to axis 11) rotated about axis 11, for example clockwise and counterclockwise, respectively.

To clarify the spatial terminology, objects 12, 13, and 14 are used. As an example, an axial surface, such as surface 15A of object 12, is formed by a plane co-planar with axis 11. However, any planar surface parallel to axis 11 is an axial surface. For example, surface 15B, parallel to axis 11 also is an axial surface. An axial edge is formed by an edge, such as edge 15C, parallel to axis 11. A radial surface, such as surface 16A of object 13, is formed by a plane orthogonal to axis 11 and co-planar with a radius, for example, radius 17A. A radial edge is co-linear with a radius of axis 11. For example, edge 16B is co-linear with radius 17B. Surface 18 of object 14 forms a circumferential, or cylindrical, surface. For example, circumference 19, defined by radius 20, passes through surface 18.

Axial movement is in direction axial direction AD1 or AD2. Radial movement is in radial direction RD1 or RD2. Circumferential, or rotational, movement is in circumferential direction CD1 or CD2. The adverbs “axially,” “radially,” and “circumferentially” refer to movement or orientation parallel to axis 11, orthogonal to axis 11, and about axis 11, respectively. For example, an axially disposed surface or edge extends in direction AD1, a radially disposed surface or edge extends in direction RD1, and a circumferentially disposed surface or edge extends in direction CD1.

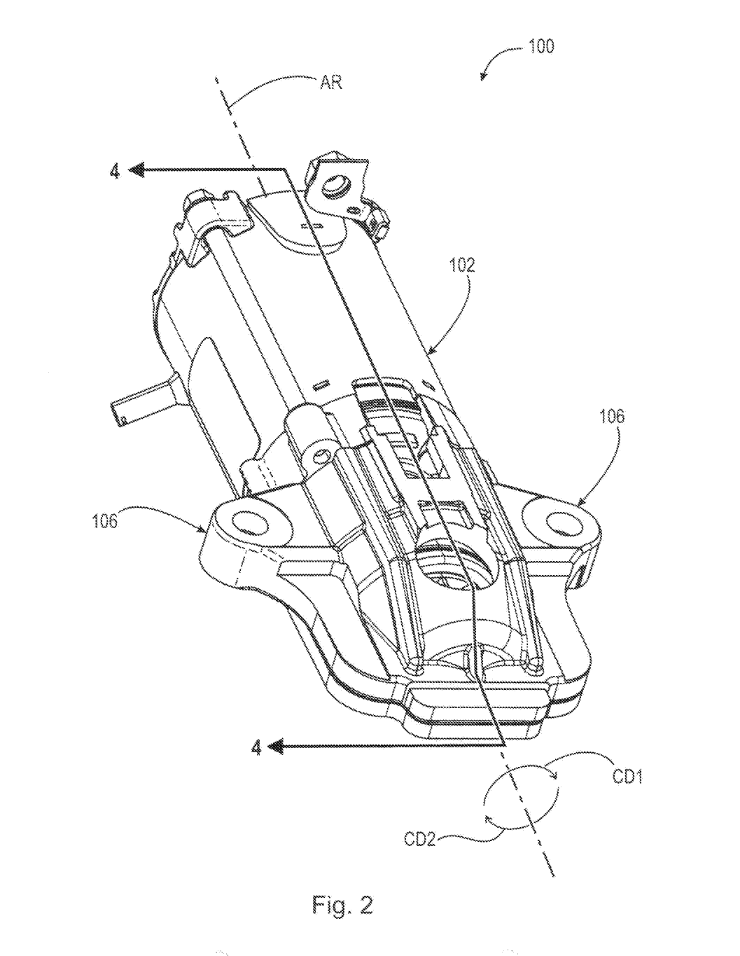

FIG. 2 is a perspective view of starter 100 with an axially fixed pinion gear.

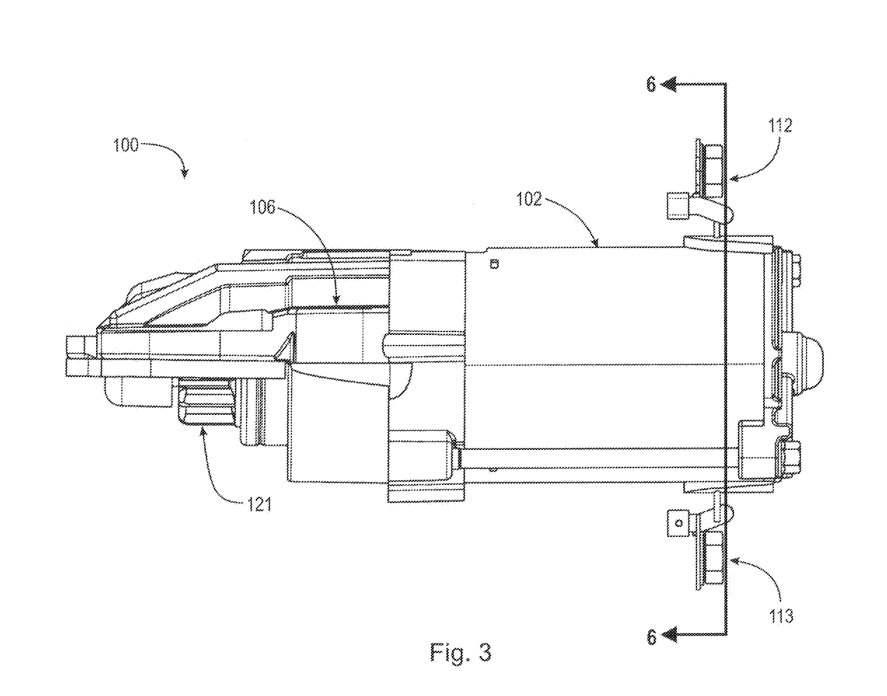

FIG. 3 is a side view of starter 100 in FIG. 2.

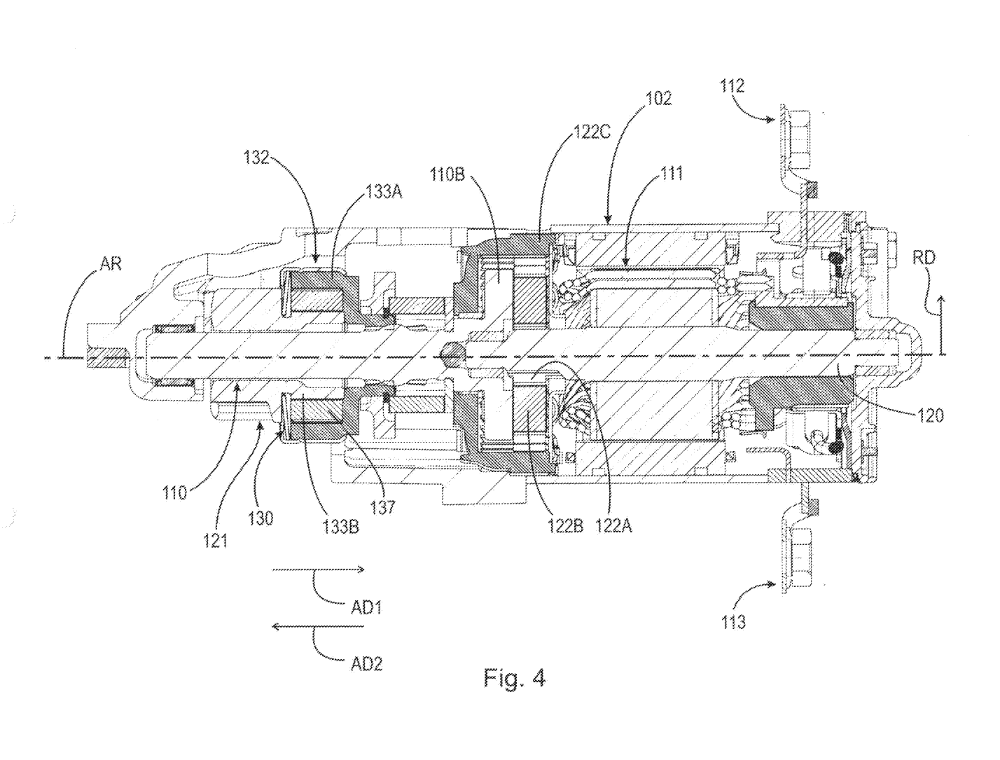

FIG. 4 is a cross-sectional view of starter 100 taken generally along line 4-4 in FIG. 2. The following should be viewed in light of FIGS. 2 through 4. Starter 100 includes housing 102, motor shaft 120 located within housing 102, electric motor 111 located within housing 102, and output shaft 110. Motor 111 is arranged to rotate motor shaft 120 in opposite circumferential directions CD1 and CD2 about axis of rotation AR. Starter 100 includes one-way clutch 132 with races 133A and 133B. Race 133A is non-rotatably connected to output shaft 110. Race 133B includes pinion gear 121. Gear 121 is arranged to mesh with a ring gear for a starting assembly (not shown) for an internal combustion engine (not shown). Pinion gear 121 is fixed, with respect to movement in opposite axial directions AD1 and AD2, parallel to axis AR, with respect to housing 102. In an example embodiment, output shaft 110 is fixed with respect to housing 102, in directions AD1 and AD2.

In an example embodiment, starter 100 includes: sun gear 122A fixed to shaft 120, planetary carrier 110B formed by output shaft 110, planet gears 122B which rotate on shafts extending from planet carrier 110B, and ring gear 122C non-rotatably connected, or grounded, to housing 102. Planet gears 122B are meshed with the sun gear and ring gear 122C. By two or more components “non-rotatably connected” we mean that whenever any one of the components rotates, the other components rotate as well. That is, the components are fixed to each other with respect to rotation.

One-way clutch 132 includes resilient element 130 directly engaged with races 133A and 133B. Element 130 can be in direct contact with races 133A and 133B or can be in direct contact with respective components non-rotatably connected to races 133A and 133B. Resilient element 130 reacts against race 133B to apply a frictional force to race 133A, or resilient element 130 reacts against race 133A to apply a frictional force to race 133B.

In an example embodiment, element 130 is a diaphragm spring with an inner circumference engaged with race 133B and an outer circumference engaged with race 133A. In an example embodiment, element 130 is in contact with a component non-rotatably connected to race 133A and/or with a component non-rotatably connected to race 133B. In an example embodiment (not shown), element 130 includes: an inner circumference engaged with race 133A; and an outer circumference engaged with race 133B.

In an example embodiment, at least a portion of race 133A is located outward of race 133B in direction RD orthogonal to axis of rotation AR. In an example embodiment, one-way clutch 132 is a trapped roller clutch including cylindrical rolling elements 137 radially disposed between races 133A and 133B.

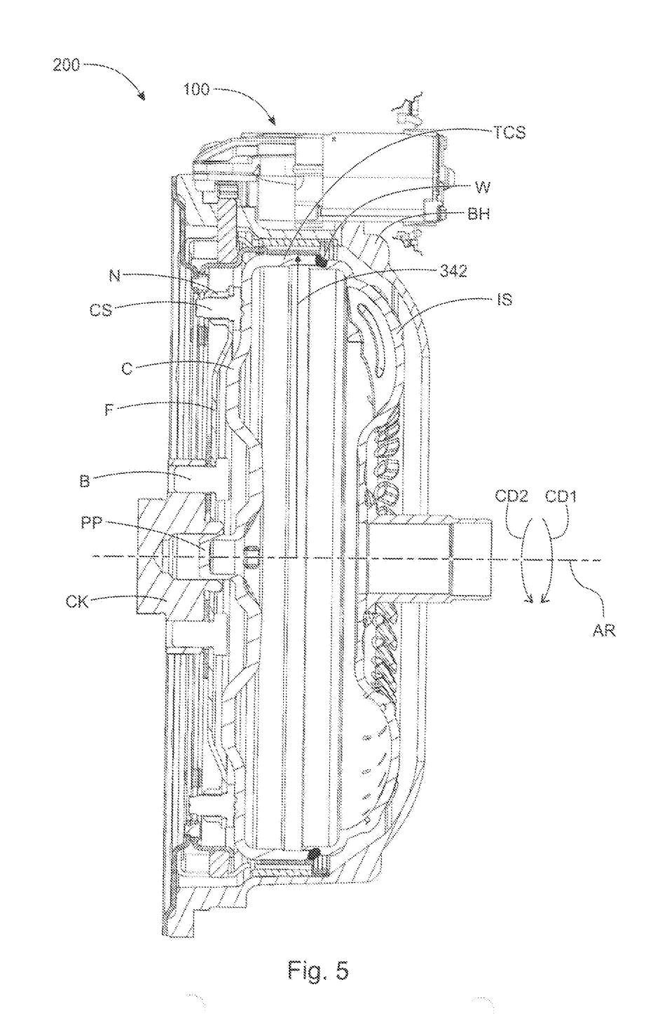

FIG. 5 is a cross-sectional view of starter assembly 200 including starter 100 of FIG. 2 and starting device 300. To clarify presentation, starter 100 is shown in a side view rather than a cross-sectional view. The following should be viewed in light of FIGS. 2 through 5. Crankshaft CK connects to torque converter shell TCS through bolts B and flexplate F. Converter studs CS are fixed to shell TCS by projection welding, and to flexplate F by nuts N. Therefore, shell TCS is drivingly engaged with crankshaft CK. Shell TSC includes impeller shell IS and cover C fixed to shell IS by weld W. Cover C includes pilot portion PP for radially centering converter shell TSC relative to crankshaft CK. Internal components such as a turbine, stator, and clutch are not shown, but are contained within shell TSC as is known in the art.

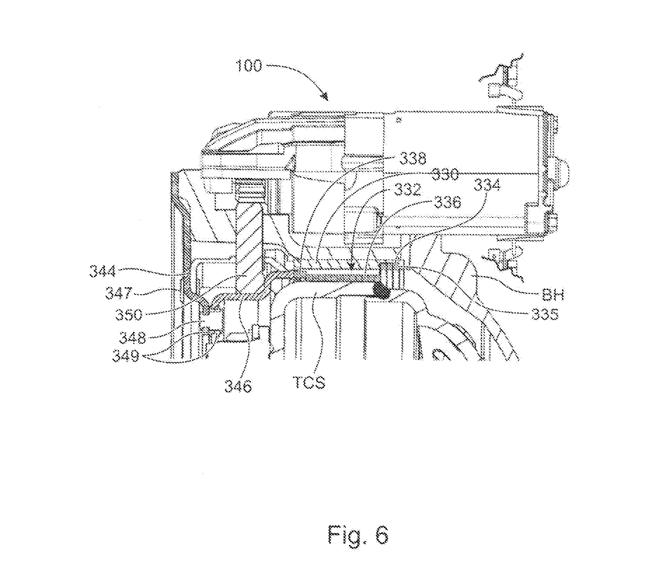

FIG. 6 is detail of FIG. 5.

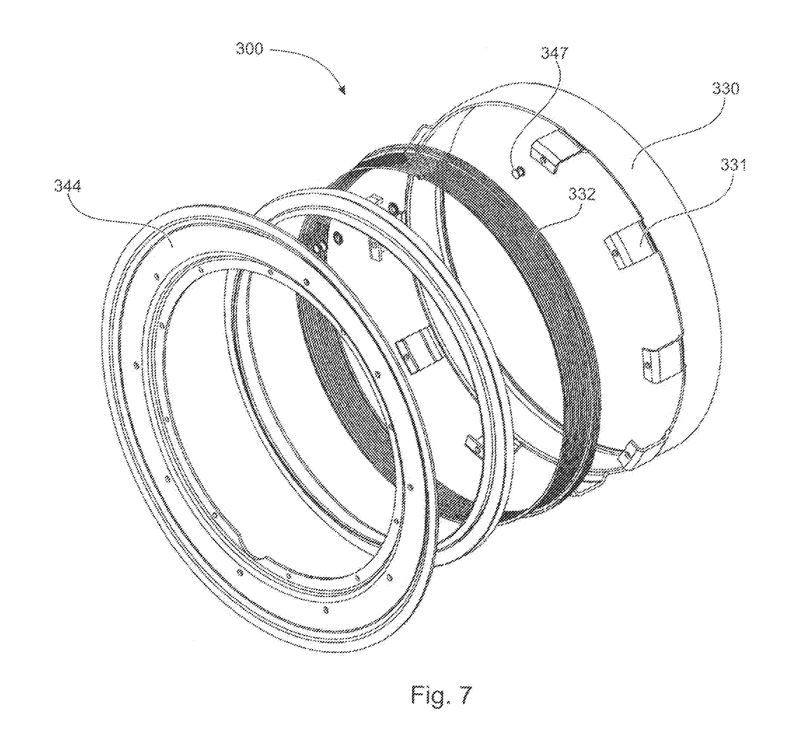

FIG. 7 is an exploded view of starting device 300 of FIG. 5. The following should be viewed in light of FIGS. 2 through 7. Starting device 300 includes spring support ring 330 and coiled clutch, or wrap spring clutch, 332. Ring 330 is fixed to centering plate 344, as described in more detail below.

Spring support ring 330 encircles clutch 332, and is frictionally engaged with friction end 334 of the clutch at circumferential groove 335. Clutch 332 also includes center portion 336 connected to end 334 and arranged for compressive engagement with shell TCS, and driven end 338 connected to center portion 336 and arranged for rotational displacement in circumferential direction CD1 relative to end 334 to compressively engage the clutch center portion 336 with shell TCS. That is, end 334 has an increased pitch and is radially compressed when it is inserted into groove 335, such that rotation of end 334 is prevented until the frictional force between end 334 and ring 330 is overcome. Otherwise stated, friction between end 334 and ring 330 resists displacement of end 334 relative to ring 330 so that end 338 may rotate relative to end 334.

Because ends 334 and 338, and portion 336 are connected, and, in some embodiments, are continuous, rotation of end 338 relative to end 334 decreases diameter 342 of center portion 336 to compressively engage shell TCS. Otherwise stated, diameter 342 of the center portion of clutch 332 decreases when end 338 is rotationally displaced relative to end 334 in direction CD1 and clutch 332 becomes drivingly engaged with shell TCS. In the embodiment shown in FIG. 5, a free diameter of end 334 is greater than a free diameter of center portion 332 so that, in a free state, end 334 is frictionally engaged with ring 330 but portion 336 is rotationally free relative to ring 330.

Starting device 300 also includes gear support plate 346. Plate 344 is fixed to support ring 330 at rivets 347 and fixed between the engine and bellhousing BH. Plate 344 may be fixed by bolts (not shown) connecting the engine and transmission or clamped between the engine and transmission when the connecting bolts are installed. Plate 344 provides centering of assembly 300 and prevents rotation of support ring 330 relative to bellhousing BH. Gear support plate 346 is drivingly engaged with clutch end 338 and rotatably connected to centering plate 344 at spacer rivets 348. By rotatably connected, we mean that plate 346 can rotate relative to plate 344, but may be restricted from motion in other directions. Rivets 348 include axially positioning rings, pulleys or wheels, 349 for locating plate 346 with low friction. That is, rivets 348 and rings 349 permit free rotation of plate 346 relative to centering plate 344. Ring gear 350 is fixed to gear support plate 346.

Ring gear 350 is drivingly engaged with pinion gear 121 such that electric motor 111 rotates gear 350 to engage clutch 332 with shell TCS to rotate a vehicle engine as described in more detail below. Gear 350 is in constant mesh with pinion gear 121. Reverse rotation of clutch 332 radially expands portion 336 against ring 330, preventing the spring from vibrating or coming out of location when the system is not in use. Ring 330 provides a continuous surface to unwind the wrap spring against.

For a start mode for assembly 200 (used to start an internal combustion engine): electric motor 111 is arranged to rotate motor shaft 120 and pinion gear 121 in circumferential direction CD1; pinion gear 121 is arranged to rotate end 138, with respect to end 134, in circumferential direction CD1; and clutch 132 is arranged to rotate torque converter shell TCS in circumferential direction CD1. For the start mode, race 133B is non-rotatably connected to race 133A.

For a first phase of a release mode for assembly 200: electric motor 111 is arranged to rotate race 133A in circumferential direction CD2, opposite circumferential direction CD1; and race 133B rotates with race 133A in circumferential direction CD2. For the first phase of the release mode, pinion gear 121 is arranged to rotate end 138, with respect to end 134, in circumferential direction CD2.

For a second phase of the release mode: electric motor 111 is arranged to rotate race 133A in circumferential direction CD2; clutch 132 is arranged to block rotation of pinion gear 121 in circumferential direction CD2; and race 133A is arranged to rotate, with respect to race 133B, in circumferential direction CD2. For example, end 138 is arranged to block rotation of pinion gear 121 in circumferential direction CD2. For example, clutch 332 is unwound and in contact with support ring 330 so that further rotation of end 338 in direction CD2 is blocked.

For the first phase of the release mode, electric motor 111 is arranged to rotate resilient element 130, race 133B and race 133A in circumferential direction CD2. For the second phase of the release mode, electric motor 111 is arranged to rotate race 133A in the circumferential direction CD2. For the second phase of the release mode: race 133A is arranged to rotate, in circumferential direction CD2, with respect to resilient element 130 and race 133B; or race 133A and resilient element 130 are arranged to rotate, in circumferential direction CD2, with respect to race 133B.

The frictional connections between resilient element 130, race 133A and race 133B can be non-rotatable connections or there can be slip between resilient element 130 and one or both of races 133A and 133B. For example: motor 111 rotates race 133A, in direction CD2, at a first speed and race 133B rotates at the first speed as well (non-rotatable connection of element 130 with races 133A and 133B); or, motor 111 rotates race 133A, in direction CD2, at a first speed and the slip/respective frictional connections result in element 130 rotating race 133B, but at a lower speed than the first speed (slip between resilient element 130 and one or both of races 133A and 133B). The slip can be between element 130 and one or both of races 133A and 133B. For example: resilient element 130 can be non-rotatably connected to race 133A and slip with respect to race 133B; resilient element 130 can be non-rotatably connected to race 133B and slip with respect to race 133A; or resilient element 130 can slip with respect to both races 133A and 133B.

In an example embodiment, element 130 is a diaphragm spring with an inner circumference engaged with race 133B and an outer circumference engaged with race 133A. In an example embodiment, element 130 is in contact with a component non-rotatably connected to race 133A and/or with a component non-rotatably connected to race 133B. In an example embodiment (not shown), element 130 includes: an inner circumference engaged with race 133A; and an outer circumference engaged with race 133B.

For the second phase, pinion gear 121 is arranged to resist, with a second force, greater than the first force, rotation in circumferential direction CD2 (for example due to the rotational fixing of end 338) and race 133A and motor shaft 120 are arranged to rotate in circumferential direction CD2 with respect to race 133B and gear 121. That is, torque from rotation of race 133A in circumferential direction CD2 is greater than the frictional force.

For the start mode: pinion gear 121 is arranged to rotate ring gear 350, ring support plate 346 and end 338 in circumferential direction CD1; and center portion 336 is arranged to rotate torque converter shell TSC in circumferential direction CD1. To transition from the start mode to the first phase of the release mode, electric motor 111 is arranged to rotate pinion gear 121, ring gear 350, ring support plate 346 and end 338 in circumferential direction CD2.

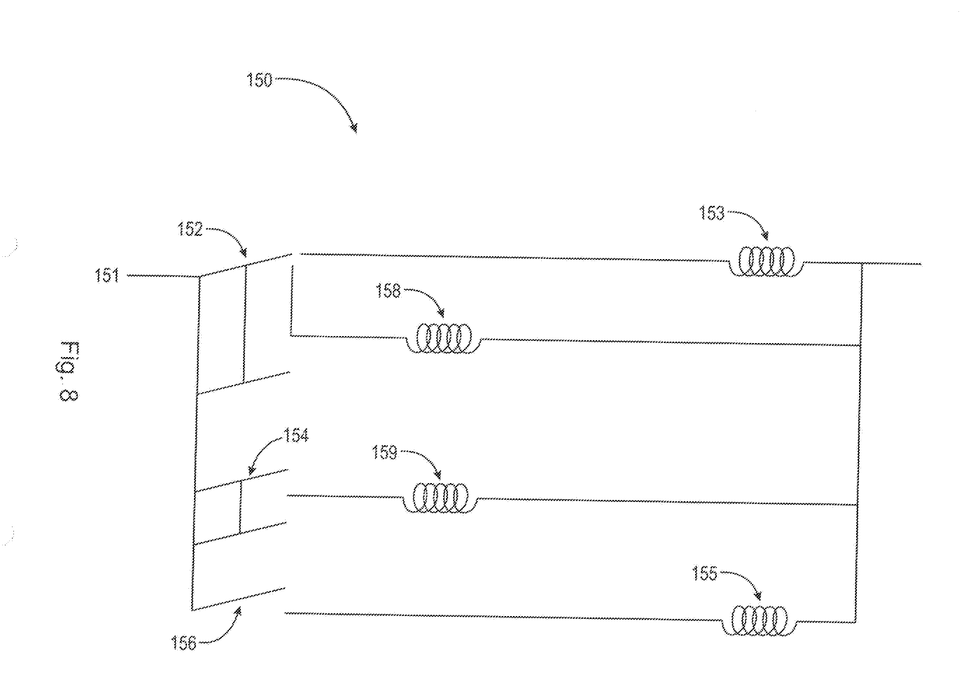

FIG. 8 is a schematic view of a control circuit for starter 100 in FIG. 2. Starter 100 includes a control circuit, for example, control circuit 150, configured to supply power to electric motor 111 to rotate motor shaft 120 in circumferential direction CD1 for the start mode, or in circumferential direction CD2 for the release mode. In an example embodiment, control circuit 150 includes battery power feed 151, starter relay switch 152, on delay timer 153, off delay timer switch 154, off delay timer 155, on delay timer switch 156, forward solenoid 158, and reverse solenoid 159.

In an example embodiment, for the start mode, control circuit 150 is configured to close switch 152 to: initiate a first time interval by triggering timer 153; and supply power to solenoid 158 to rotate motor shaft 120 in direction CD1. In an example embodiment, for the release mode, control circuit 150 is configured to close switches 154 and 156, upon expiration of the first time interval to. Switch 154 supplies power to solenoid 159 to rotate motor shaft 120 in circumferential direction CD2. Switch 156 initiates a second time interval by triggering timer 155. Upon expiration of the second time interval: circuit 150 is arranged to open switch 154 to turn off power to electric motor 111 and open switch 156.

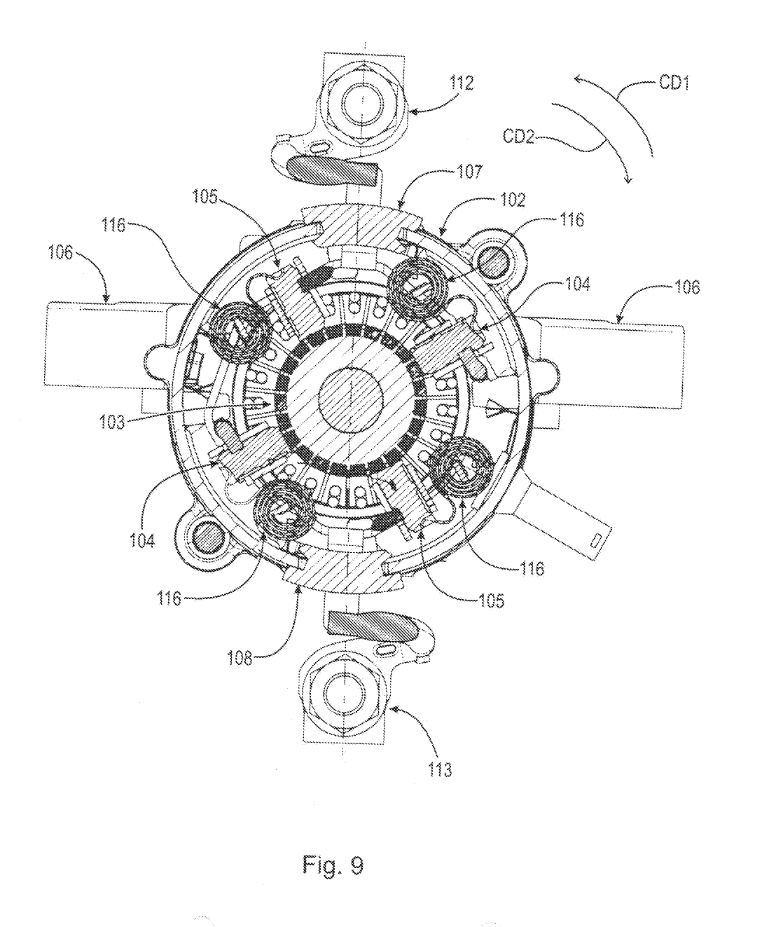

FIG. 9 is a cross-sectional view of starter 100 taken generally along line 9-9 in FIG. 3. In an example embodiment, electric motor 111 includes armature 103 and brushes 104 and 105. To enable rotation of motor 111 in directions CD1 and CD2, normally grounded brushes 104 are electrically isolated from housing 102. Motor 111 includes separate leads 107 and 108 for brushes 104 and 105, respectively, and mounts 112 and 113 for leads 107 and 108, respectively. Springs 116 maintain contact between armature 103 and brushes 104 and 105.

Advantageously, assembly 200 and starter 100 eliminate the problem noted above with respect to an axially displaceable pinion for a starter engaging with and disengaging from a ring gear. Specifically, output shaft 310 remains engaged with a ring gear at all times, not just during a starting sequence.

Advantageously, assembly 200 and starter 100 eliminate the problem noted above with respect to a wrap spring clutch not properly unwinding to terminate a starting mode. Specifically, once the start mode is complete and clutch 332 is fully wound in direction CD1, motor 111 rotates, during the first phase of the release mode, pinion gear 121 and ring gear 350 in direction CD2 to displace end 338 in direction CD2 and initiate the unwinding of clutch 332. Without resilient element 130, race 133B would free wheel with respect to race 133A for rotation of motor 111 in direction CD2. However, as noted above, a friction force between element 130 and races 133A and 133B keeps races 133A and 133B rotating in direction CD1. Pinion gear 121 continues to rotate ring gear 350 and end 338 to ensure a smooth and continuous unwinding of clutch 332.

When clutch 332 is fully unwound in the second phase of the release mode, further rotation of end 338 in direction CD2 is blocked. Thus, rotation of ring 350 and pinion gear 121 in direction CD2 also is blocked. However, damage to motor 111 caused by attempting to rotate shaft 120 in direction CD2 when rotation of races 133A and 133B in direction CD2 is blocked, is prevented. Specifically, the torque from motor 111 overcoming the friction force connecting races 133A and 133B, enabling clutch 132 to free-wheel. The magnitude of the friction force can be selected to enable successful completion of the first phase of the release mode, while minimizing the torque needed to initiate the second phase of the release mode.

It should be understood that directions CD1 and CD2 can be reversed from the orientation shown in the figures.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A starter assembly for a motor vehicle, comprising:
a starter including:
a housing;
an electric motor located within the housing and including a motor shaft;
an axis of rotation for the motor shaft;
an output shaft non-rotatably connected to the motor shaft; and,
a one-way clutch including:
a first race including a pinion gear, the pinion gear fixed with respect to axial movement, parallel to the axis of rotation, with respect to the housing; and,
a second race non-rotatably connected to the output shaft; and,
a starting device including a wrap spring clutch with a first end and a second end, wherein:
the first race and the pinion are non-rotatably connected;
for a start mode:
the electric motor is arranged to rotate the motor shaft and the pinion gear in a first circumferential direction;
the pinion gear is arranged to rotate the second end, with respect to the first end, in the first circumferential direction; and,
the wrap spring clutch is arranged to rotate a torque converter shell in the first circumferential direction; and,
for a first phase of a release mode:
the electric motor is arranged to rotate the second race in a second circumferential direction, opposite the first circumferential direction; and,
the first race rotates in the second circumferential direction.

2. The starter assembly of claim 1, wherein for a second phase of the release mode:
the electric motor is arranged to rotate the second race in the second circumferential direction;
the wrap spring clutch is arranged to block rotation of the pinion gear in the second circumferential direction; and,
the second race is arranged to rotate, with respect to the first race, in the second circumferential direction.

3. The starter assembly of claim 1, wherein for the first phase of the release mode, the pinion gear is arranged to rotate the second end, with respect to the first end, in the second circumferential direction.

4. The starter assembly of claim 1, wherein for the start mode, the first race is a non-rotatably connected to the second race.

5. The starter assembly of claim 1, wherein:
the one-way clutch includes a resilient element frictionally engaged with the first and second races;
for the first phase of the release mode, the electric motor is arranged to rotate the resilient element, the first race and the second race in the second circumferential direction; and,
for a second phase of the release mode:
the electric motor is arranged to rotate the second race in the second circumferential direction; and,
the second race is arranged to rotate, in the second circumferential direction, with respect to the resilient element and the first race; or,
the second race and the resilient element are arranged to rotate, in the second circumferential direction, with respect to the first race.

6. The starter assembly of claim 5, wherein:
the resilient element connects the first and second races with a frictional force; and,
for the second phase of the release mode, a torque from rotation of the second race in the second circumferential direction is greater than the frictional force.

7. The starter assembly of claim 1, wherein:
the wrap spring clutch includes a center portion connected to the first end and to the second end;
the starting device includes a ring gear drivingly engaged with the pinion;
for the start mode:
the pinion is arranged to rotate the ring gear in the first circumferential direction; and,
the center portion is arranged to rotate the torque converter shell in the first circumferential direction; and,
to transition from the start mode to the first phase of the release mode, the electric motor is arranged to rotated the ring gear in the second circumferential direction.

8. The starter assembly of claim 7, wherein:
the starting device includes a ring support plate drivingly engaged with the ring gear and the second end;
for the start mode the pinion is arranged to rotate the ring support plate in the first circumferential direction; and,
to transition from the start mode to the first phase of the release mode, the electric motor is arranged to rotate the pinion gear and the ring support plate in the second circumferential direction.

9. The starter assembly of claim 8, wherein:
the starting device includes a spring support ring fixed against rotation; and,
the first end is frictionally engaged with the spring support ring.

10. The starter assembly of claim 1, wherein for a second phase of the release mode:
the electric motor is arranged to rotate the second race in the second circumferential direction;
the second end is arranged to block rotation of the pinion in the second circumferential direction; and,
the second race is arranged to rotate, with respect to the first race, in the second circumferential direction.

11. The starter assembly of claim 7, wherein for the start mode, the first race is a non-rotatably connected to the second race.

12. The starter assembly of claim 7, wherein:
the one-way clutch includes a resilient element frictionally engaged with the first and second races;
for the first phase of the release mode, the resilient element, the first race and the second race are arranged to rotate in the first circumferential direction; and,
for a second phase of the release mode:
the electric motor is arranged to rotate the second race in the second circumferential direction; and,
the second race is arranged to rotate, in the second circumferential direction, with respect to the resilient element and the first race; or,
the second race and the resilient element are arranged to rotate, in the second circumferential direction, with respect to the first race.

13. A starter assembly for a motor vehicle, comprising:
a starter including:
a housing;
an electric motor located within the housing and including a motor shaft;
an axis of rotation for the motor shaft;
an output shaft non-rotatably connected to the motor shaft; and,
a one-way clutch including:
a first race including a pinion gear, the pinion gear fixed with respect to axial movement, parallel to the axis of rotation, with respect to the housing;
a second race non-rotatably connected to the output shaft; and,
a resilient element frictionally engaged with the first and second races; and,
a starting device including a wrap spring clutch with a first end and a second end, wherein:
the first race and the pinion are non-rotatably connected;
for a start mode:
the electric motor is arranged to rotate the motor shaft and the pinion gear in a first circumferential direction;
the pinion gear is arranged to rotate the second end, with respect to the first end, in the first circumferential direction; and,
the wrap spring clutch is arranged to rotate a torque converter shell in the first circumferential direction; and,
for a first phase of a release mode:
the electric motor is arranged to rotate the second race in a second circumferential direction, opposite the first circumferential direction; and,
the resilient element, the first race and the second race are arranged to rotate in the first circumferential direction.

14. The starter assembly of claim 13, wherein for the first phase of the release mode, the pinion is arranged to rotate the second end, with respect to the first end, in the second circumferential direction.

15. The starter assembly of claim 13, wherein for a second phase of the release mode:
the electric motor is arranged to rotate the second race in the second circumferential direction;
the second end is rotationally fixed with respect to the first end;
the second end is arranged to block rotation of the pinion in the second circumferential direction; and,
the second race is arranged to rotate, with respect to the first race, in the second circumferential direction.

16. The starter assembly of claim 13, wherein:
the starting device includes:
a ring gear drivingly engaged with the pinion gear;
a ring support plate drivingly engaged with the ring gear and the second end; and,
a non-rotatable spring support ring;
the first end is frictionally engaged with the spring support ring;
for the start mode, the pinion is arranged to rotate the ring gear, the ring support plate and the second end in the first circumferential direction; and,
to transition from the start mode to the first phase of the release mode, the electric motor is arranged to rotate the ring gear, the ring support plate and the second end in the second circumferential direction.

17. A starter assembly for a motor vehicle, comprising:
a starter including:
a housing;
an electric motor located within the housing and including a motor shaft;
an axis of rotation for the motor shaft;
an output shaft non-rotatably connected to the motor shaft; and,
a one-way clutch including:
a first race including a pinion gear, the pinion gear fixed with respect to axial movement, parallel to the axis of rotation, with respect to the housing; and,
a second race non-rotatably connected to the output shaft; and,
a starting device including:
a wrap spring clutch with:
a first end;
a center portion connected to the first end; and,
a second end connected to the center portion;
a ring gear drivingly engaged with the pinion gear; and,
ring support plate drivingly engaged with the ring gear and the second end, wherein: the first race and the pinion are non-rotatably connected;
for a start mode:
the electric motor is arranged to:
rotate the pinion, the ring gear, and the ring support gear in a first circumferential direction; and,
rotate the second end, with respect to the first end, in the first circumferential direction; and,
the center portion is arranged to engage and rotate a torque converter shell in the first circumferential direction; and,
to transition from the start mode to a first phase of a release mode, the electric motor is arranged to rotate:
the pinion gear, the ring gear and the ring support plate in a second circumferential direction, opposite the first circumferential direction; and,
the second end, with respect to the first end, in the second circumferential direction.

18. The starter assembly of claim 17, wherein for a second phase of the release mode:
the electric motor is arranged to rotate the second race in the second circumferential direction;
the second end is rotationally fixed with respect to the first and is arranged to block rotation of the pinion in the second circumferential direction; and,
the second race is arranged to rotate, with respect to the first race, in the second circumferential direction.

19. The starter assembly of claim 17, wherein:
the starting device includes a spring support ring fixed against rotation; and,
the first end is frictionally engaged with the spring support ring.

20. The starter assembly of claim 17, wherein:
the one-way clutch includes a resilient element frictionally engaged with the first and second races;
for the first phase of the release mode, the electric motor is arranged to rotate the resilient element, the first race and the second race in the first circumferential direction; and,
for a second phase of the release mode:
the electric motor is arranged to rotate the second race in the second circumferential direction; and,
the second race is arranged to rotate, in the second circumferential direction, with respect to the resilient element and the first race; or,
the second race and the resilient element are arranged to rotate, in the second circumferential direction, with respect to the first race.
